(19) United States
(12) Patent Application Publication
(10) Pub. No.: US 2015/0188928 A1
(43) Pub. Date: Jul. 2, 2015

(54) PRIVATE-PUBLIC CHAT FUNCTIONALITY

(71) Applicant: OnCam, Inc., Beverly Hills, CA (US)

(72) Inventor: Joseph Shapiro, Paradise Valley, AZ (US)

(73) Assignee: OnCam, Inc., Beverly Hills, CA (US)

(21) Appl. No.: 14/143,945

(22) Filed: Dec. 30, 2013

(51) Int. Cl. H04L 29/06; H04L 12/58

(52) U.S. Cl. CPC H04L 63/105; H04L 51/16

(57) ABSTRACT

There is disclosed a system and a method for public-private chat functionality. The method includes initiating a private chat between a first chat participant using a first computing device and a second chat participant using a second computing device and receiving a request to convert the private chat into a public chat available for viewing by a plurality of non-participating chat viewers, the request from the first computing device. The method further includes receiving an acceptance of the request to convert from the second computing device, automatically sending a notification to followers of at least one of the first chat participant and the second chat participant that the public chat is about to commence, and enabling access to the chat by the plurality of non-participating chat viewers.

### RELATED APPLICATION INFORMATION

This patent is related to U.S. patent application Ser. No. ______ filed ______ and entitled “ONE-CLICK VIDEO CHAT INITIATION” and the U.S. patent application Ser. No. ______ filed ______ and entitled “REAL TIME STREAM PROVISIONING INFRASTRUCTURE.”

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a public-private chat functionality for use in audio-visual multi-user chat interactions.

2. Description of the Related Art

Audio-visual chat has been available among a plurality of computer users for some time. For example, Skype® enables audio-visual user-to-user calling via a peer-to-peer system with server-based initiation and messaging protocols. More recently, Skype®, Facetime®, and Google® Hangouts have enabled various permutations of so-called “group” audio-visual chat sessions. Facetime® and Skype® also enable mobile-to-mobile single-user-to-single-user audio-visual calling.

In a related field, websites such as YouTube®, Netflix® and Vimeo® have enabled streaming of stored videos. Sites such as UStream® and Twit.tv® have enabled real time or “live” (or nearly-live) audio-visual streaming. Stored video streaming has relied upon conversion of the video into a format suitable for low-bandwidth streaming. Services like Facebook® or Google+® enable individuals to notify connections or members of their “circles” that they are available for video chat or a hangout. Instant messaging applications have enabled person-to-person video chat for some time.

### DESCRIPTION OF THE DRAWINGS

FIG. 1 is a block diagram of a real time stream provisioning infrastructure.

FIG. 2 is a block diagram of a computing device.

FIG. 3 is a block diagram of an encoding computing device.

FIG. 4 is a functional diagram of a real time stream provisioning infrastructure

FIG. 5 is a functional diagram of a server and a communication system for video encoding.

FIG. 6 is a functional diagram of a server and a communication system for audio encoding.

FIG. 7 is a flowchart of a public-private chat process.

FIG. 8 is a flowchart of a process of joining private-public chat.

FIG. 9 is a flowchart of a process of adding and removing public chat participants.

FIG. 10 is a graphical user interface for a public-private chat.

FIG. 11 is a graphical user interface for making a private chat into a public chat.

FIG. 12 is a graphical user interface for adding a viewer as a participant in a public chat.

FIG. 13 is a graphical user interface for removing a participant or making a public chat private.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

Until now, no service has enabled a group participating in a person-to-person private chat to convert that private chat into a public chat for viewing by any number of non-participating viewers. No service has enabled automatic notification, via social networks or a software application, of a previously-private, now-public chat and an invitation to view the public chat. No service has enabled a viewer to be automatically joined to the now-public chat upon receipt of a public chat notification from a specific user.

Furthermore, no services have enabled the now-public chat to periodically incorporate one or more of the viewers as a participant for a predetermined period of time or until the original participants have determined that the new viewer should again become a non-participating viewer. Finally, no service has enabled a public chat, including a plurality of non-participating viewers, to be returned to a private chat involving only those participants and no longer streaming for public viewing.

Description of Apparatus

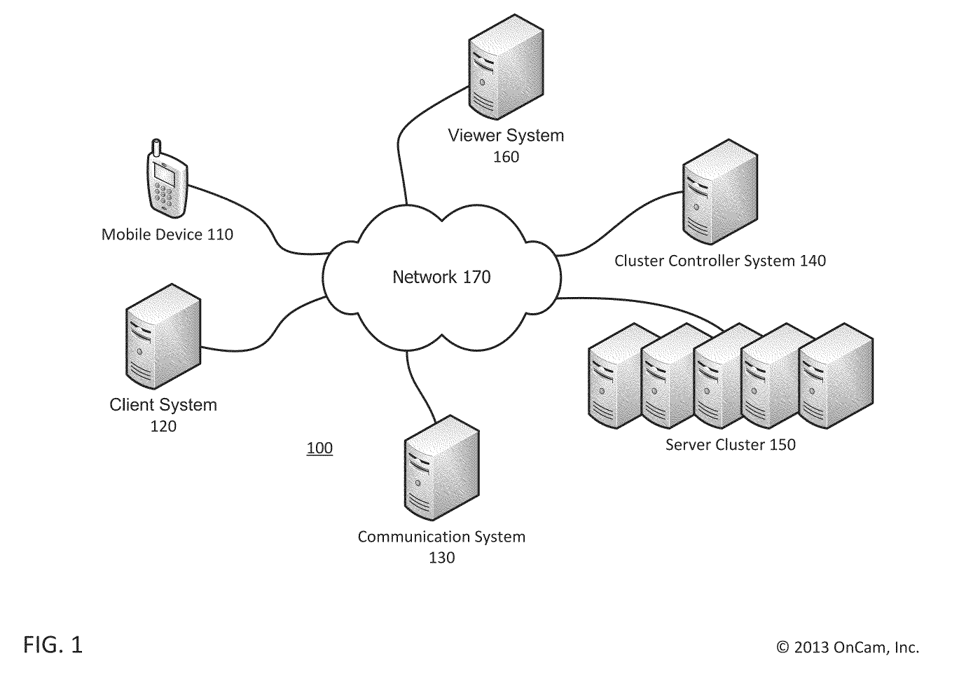

Referring now to FIG. 1, there is shown a block diagram of an environment for search and ranking of procedures to complete a task. The environment 100 includes a mobile device 110, a client system 120, a communication system 130, a cluster controller system 140, a server cluster 150, and a viewer system 160. Each of these elements are interconnected via a network 170.

The mobile device 110 and client system 120 are computing devices (see FIG. 1) that are used by chat participants and viewers in order to take part in or to view a chat. The mobile device 110 may be a mobile phone including a screen, a microphone and a video camera. The client system 120 may be a personal desktop computer, a tablet, a laptop or a similar device including a screen, a microphone and a video camera. The screen, microphone and video camera may be independent of or integral to either the mobile device 110 or the client system 120.

For purposes of this patent, the term “chat” means an audio and/or video simultaneous communication involving at least two chat participants. A “chat participant” is an individual taking part in a chat, using a mobile device 110 or a client system 120, and providing an audio and/or video component making up a part of the chat. A “chat viewer,” in contrast, is an individual viewing a chat, but not providing any audio and/or video component making up a part of the chat. In some situations, a “chat viewer” may, permanently or temporarily, be converted into a chat participant, either of their own volition, if allowed by the system, by an administrator of a chat, or by another chat participant.

An “audio component,” a “video component” or an “audio-visual component” as used herein means an audio and/or video stream provided by a single chat participant. A “combined” audio and video stream or audio-visual stream is an audio and/or video stream simultaneously incorporating the components of more than one chat participant in a single stream. A “master” audio stream, video stream, or audio-visual stream is an audio and/or video stream simultaneously incorporating the components of all chat participants.

The communication system 130 is a computing device that is responsible for routing communications, such as chat initiation requests, any text-based communication between chat participants and viewers, any unique chat identifiers, and the protocol communications necessary to establish, initiate, maintain, and end chat sessions. The communication system 130 may enable peer-to-peer sessions to be initiated. The communication system 130 may be made up of more than one physical or logical computing device in one or more locations.

The cluster controller system 140 is a computing device that is responsible for receiving chat initiation (and termination) requests and then identifying and allocating a server, from the server cluster 150, to handle audio-visual chats. The cluster controller system 140 may also maintain a full database of all ongoing chats and each participant in the ongoing chats. The cluster controller system 140 may operate as an organizer of the overall audio-visual chat process. In situations in which a server, from the server cluster 150, ceases to function or is no longer reachable on the network, the cluster controller system 140 may transition an in-process audio-visual chat to a newly-provisioned server within the server cluster 150.

The server cluster 150 is a group of servers that are available to be used to host one or more audio-visual chats. A server within the server cluster 150 is used to receive a plurality of audio and/or video components from a plurality of chat participants and to encode those into one or more combined audio and/or video streams. The server cluster 150 may, for example, be a set of dynamically available servers that may be allocated on an as-needed basis for use in one or more audio-visual chats. Amazon® and Microsoft® currently offer such servers that may be paid-for on an as-needed basis. As discussed more fully below, the servers making up the server cluster 150 each incorporate at least one graphical processing unit (GPU) for use in encoding audio and/or video.

The viewer system 160 is a computing device that is used to view an on-going audio-visual chat. The viewer system 160 is essentially the same as the mobile device 110 and the client system 120, but is used by a chat viewer. As a result, the viewer system 160 does not provide an audio and/or video component for inclusion in the chat. Instead, the viewer system 160 merely receives an audio and/or video stream.

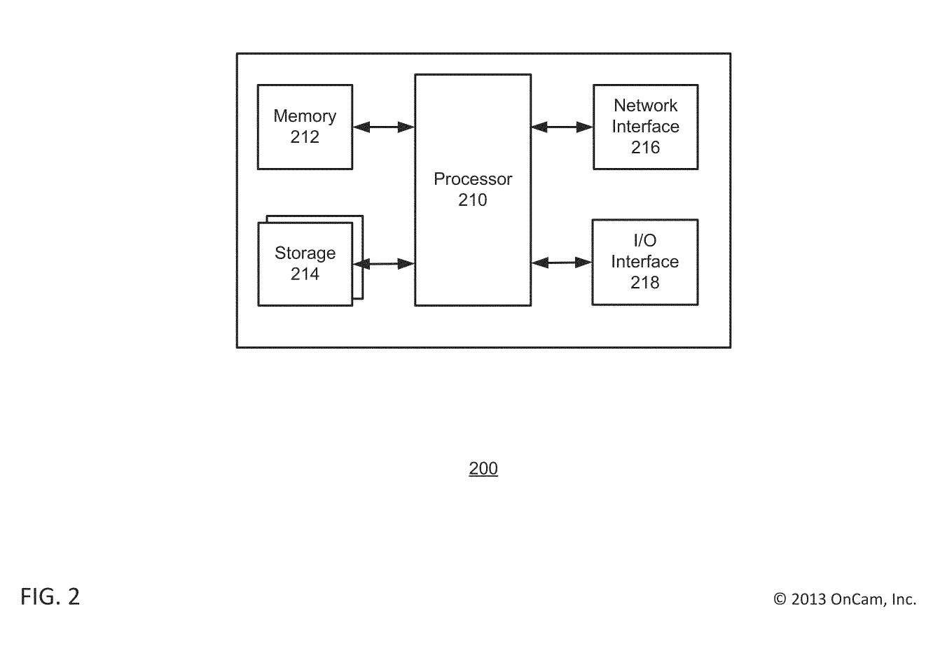

Turning now to FIG. 2 there is shown a block diagram of a computing device 200, which is representative of the mobile device 110, the client system 120, the communication system 130, the cluster controller system 140, and the viewer system 160 in FIG. 1. The computing device 200 may be, for example, a desktop or laptop computer, a server computer, a tablet, a smartphone or other mobile device. The computing device 200 may include software and/or hardware for providing functionality and features described herein. The computing device 200 may therefore include one or more of: logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor 210 may be or include one or more microprocessors, field programmable gate arrays (FPGAs), application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a magnetic or solid state disk, tape, CD, DVD, or other reasonably high capacity addressable or serial storage medium. Multiple storage devices may be provided or available to the computing device 200. Some of these storage devices may be external to the computing device 200, such as network storage or cloud-based storage. As used herein, the term storage medium corresponds to the storage 214 and does not include transitory media such as signals or waveforms. In some cases, such as those involving solid state memory devices, the memory 212 and storage 214 may be a single device.

The network interface 216 includes an interface to a network such as network 170 (FIG. 1). The network interface 216 may be wired or wireless.

The I/O interface 218 interfaces the processor 210 to peripherals (not shown) such as displays, video cameras, microphones, keyboards and USB devices.

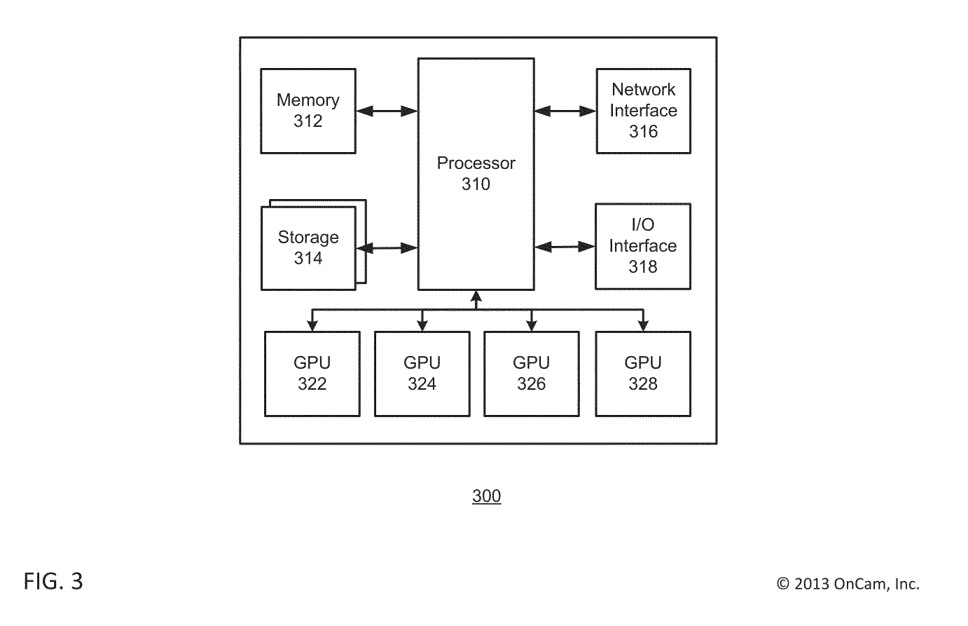

Turning now to FIG. 3 there is shown a block diagram of an encoding computing device 300, which is representative of the servers making up the server cluster 150 in FIG. 1. The processor 310, memory 312, storage 314, network interface 316 and I/O interface 318 of FIG. 3 serve the same function as the corresponding elements discussed with reference to FIG. 2 above. These will not be discussed further here.

The GPUs (graphical processing units) 322, 324, 326, and 328 are also present in this computing device 300. There may be more or fewer GPUs dependent upon the needs of the computing device 300. GPUs, such as GPU 322, are specialized processors including instruction sets designed specifically for processing visual-related algorithms. GPUs differ from CPUs (such as processor 310) primarily in that they are capable of interacting with memory directly allocated to the GPU very rapidly and, as a result, can manipulate the large quantities of data pertaining to computer visual functions stored in that memory very rapidly. In addition, GPUs typically incorporate a “frame buffer” which stores processed data in a format suitable for near-direct output to a computer display. Finally, GPUs, unlike most CPUs, offer high parallelism that enables them to process large blocks of data simultaneously.

In addition, multiple GPUs may be incorporated into a single computing device 300 to enable simultaneous processing by multiple GPUs. The computing device 300 may include, for example, five GPUs, each operating independently from one another and communicating with a single CPU (such as processor 310). As used herein a GPU is distinct from and in addition to a CPU. A GPU, as used herein, incorporates at least one specific instruction set for operating upon computer graphical data. The instruction set specific to the GPU and is not incorporated in the CPU.

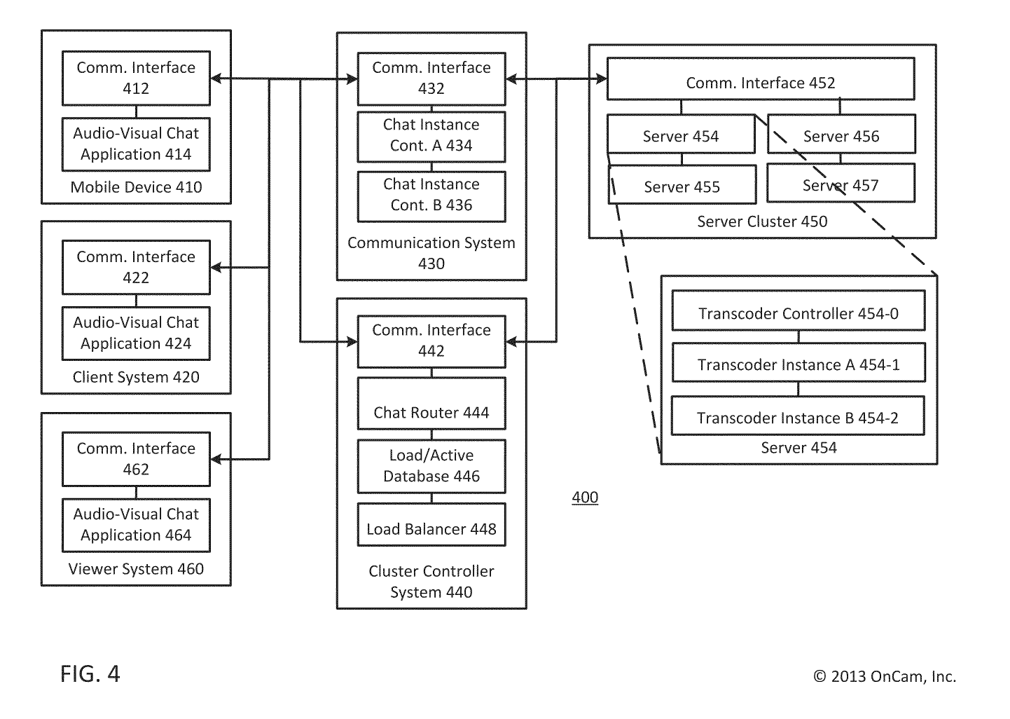

Turning now to FIG. 4, a functional diagram of a real time stream provisioning infrastructure 400 is shown. FIG. 4 corresponds to FIG. 1, but includes more detail regarding the functional elements making up the individual computing devices. As such, the mobile device 410, the client system 420, the communication system 430, the cluster controller system 440, the server cluster 450 and the viewer system 460 each have counterparts in FIG. 1.

The mobile device 410 and client system 420, each include a communication interface 412, 422 and an audio-visual chat application 414, 424. The communication interface 412, 422 are used to enable textual chat between chat participants. The textual chat may take the form of an asynchronous communication between the chat participants and may include text, images (such as .jpg, .gif) and embedded videos (such as from YouTube® and similar video sharing sites).

The communication interface 412, 422 is also used to transfer signaling and protocol related messages pertaining to the creation, maintenance and ending of chats between the mobile device 410, the client system 420, any viewer systems 460 and the cluster controller system 440 and the server cluster 450. These messages signal to the communication system 430 which then signals messages to cluster controller system 440, the server cluster 450 and to the mobile devices and client systems associated with chat participants that at least one chat participant wishes to initiate, continue, and/or end a chat. In addition, messages identifying the chat participants and any viewers and, potentially, identifying the types of computing devices used for those chats, the connection, the status of whether those chat participants or viewers remain and numerous other types of information that may be relevant to the cluster controller system 440, the server cluster 450, using the communication system 430, and communication interface 412, 422.

The audio-visual chat application 414, 424 operate to receive audio and/or video components provided by a chat participant using either a mobile device 410 or a client system 420 and to cause those components to be transmitted to (or through) a cluster controller system 440 for combination into one or more combined streams. The audio-visual chat application 414, 424 may then receive the one or more combined streams and display those to a chat participant using the mobile device 410 or the client system 420.

The communication system 430 uses a communication interface 432 to communicate chat requests, initiation messages, chat end messages, and related protocol messages to and from chat participants and any of the infrastructure 400 elements. The communication system 430 may provide, for example, a uniform resource locator (URL) for a particular chat session or a particular chat participant. This URL may redirect requests to an associated real-time audio and/or video stream.

The communication system 430 also includes chat instance controllers, such as chat instance controller A 434 and chat instance controller B 436, for each concurrent chat operating on the system. These controllers 434 and 436 operate as central hubs for all protocol, text, audio components and video components making up a part of a particular chat. A chat may be identified by a particular chat ID, with protocol messages, text, audio components and video components directed to the communication system using the chat ID to determine which chat instance controller the data is directed.

One example of a communication system like the communication system 430 is a system currently provided by Wowza® which enables publication of audio and video components by individual users and further enables publication of a resulting combined or master stream to a plurality of chat participants and chat viewers. Wowza®, among other things, incorporates a protocol for initiating the broadcast (or transmission) of those streams and for receipt of the combined stream for broadcasting to an identified group of chat participants and chat viewers. These protocols are an example of the communication protocols used by the communication interface 412, 422, although many other systems offering similar functionality may be used. Additional or different systems may make up all or a part of the communication system 430 which may also enable text chat, routing of protocol messages, sharing of audio/visual data via social networks, social network API integration, instant messaging and other, similar functions.

The cluster controller system 440 is primarily responsible for acting as an orchestrator and a conduit for audio component and video component encoding operations that are passed to the server cluster 450. The cluster controller system 440 incorporates a communication interface 432, a chat router 444, a load/active database 446 and a load balancer 448. The communication interface 442 operates, in conjunction with the communication system 430, to receive and route chat requests, maintenance messages and chat termination messages.

The chat router 444 operates to direct incoming audio and/or video components from one or more chat participants to a server within the server cluster (or to a newly-allocated server) for encoding of the audio and/or video components into one or more combined streams. The load/active database 446 maintains a database of all on-going chats and all participants and viewers for each of those chats. This enables the cluster controller system 440 to determine which audio and/or video components and which combined and master streams pertain to which chats and/or chat participants and chat viewers.

In addition, the load/active database 446 maintains a database of the overall load associated with the encoding operations of each server making up the server cluster 450. This enables the cluster controller system 440 to determine which server, of the server cluster 450, would be best-suited to service a new chat and when to activate additional servers available to the server cluster 150 in order to avoid overextending one or more server's capacity to host chats.

Similarly, the load balancer 448 uses the information in the load/active database to activate new servers, deactivate unused (or underused) servers, to transfer ongoing chats in real-time to less-utilized servers and to otherwise ensure that an efficient use of the server cluster 450 is taking place. In the event of a server failure, the load balancer 448 may use the information in the load/active database 446 to quickly transition all ongoing chats to one or more other servers.

The server cluster 450 is a group of servers 454, 455, 456, 457 and an associated communication interface 452 that are responsible for encoding multiple audio and/or video components into one or more combined or master streams.

Each server in the server cluster 450, such as server 454, can include a transcoder controller 454-0 that is responsible for directing transcoding of audio and/or video components and other messages to one of a plurality of transcoder instances 454-1, 454-2 operating on that server 454. The transcoder controller 454-0 may also report back usages and load data to the load/active database 446 for use by the load balancer 448. Incoming audio and/or video components may only be identified by a chat ID, and the transcoder controller 454-0 may use that to direct the stream to the appropriate transcoder instance.

The transcoder instances A 454-1 and B 454-2 are responsible for directing one or more GPUs on the server 454 to transcode audio and/or video components into a series of combined audio and/or video streams for service back to one or more of the chat participants.

The viewer system 460 operates in virtually the same fashion as the mobile device 410 and the client system 420. However, the audio-visual chat application 464 of a chat viewer using the viewer system 460 does not provide an audio and/or video component for combination into a combined or master stream.

As indicated above, the chat viewer using the viewer system 460 may, temporarily or permanently, become a chat participant. In such a case, the communication interface 462 communicates a desire to become a chat participant in an ongoing chat or in a new chat, the communication system 430 provisions that chat in interaction with the cluster controller system 440 and adds the chat viewer (now participant) to a chat instance on a server available to the server cluster 450.

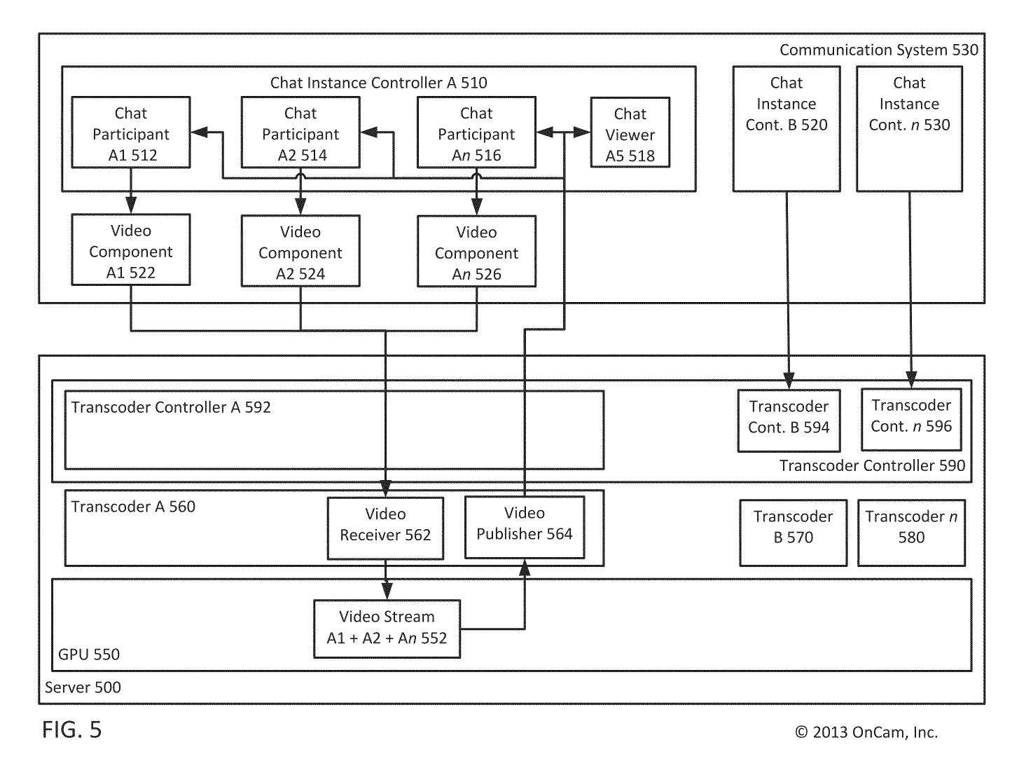

FIG. 5 is a functional diagram of server 500 and a communication system for video encoding 530. The server 500 is one of the servers in a server cluster, such as server cluster 450 in FIG. 4. The communication system 530 may be the communication system 430 of FIG. 4. All communication in the system may be routed through the communication system 530, may utilize one or more APIs operating on the server 500 or within the various elements allocated for a particular chat instance. For example, an API within a given transcoder controller may communicate, using the communication system 530, directly with a chat instance controller for that chat instance.

The communication system 530 includes a plurality of chat instance controllers A 510, B 520, and n 530. The chat instance controller A 510, as discussed above, ensures that video received by the system that is associated with a particular chat instance is routed and returned to the appropriate chat instance for chat participants and any chat viewers.

The server 500 includes a transcoder controller 590, transcoders A 592, B 594 and n 596, and a GPU 550. The transcoder controller 590 controls the operation of the transcoders A 592, B 594, and n 596. The transcoder controllers A 592, B 594 and n 596 are responsible for directing the conversion of audio and video components received from their respective chat instance controllers A 510, B 520, and n 530 into combined or master audio or video streams while under the direction of transcoder controller 590. The transcoding takes place on the GPU 550.

Each transcoder, such as transcoder A 560, includes a video receiver, such as video receiver 562, and a video publisher, such as video publisher 564. Each video receiver 562 receives each of the video components for the chat instance controller associated with the transcoder. For example, the video receiver 562 for transcoder A 560 receives the video components A1 522, A2 524, and An 526 associated with chat instance controller A 510.

The video components are then provided by the video receiver 562 to the GPU 550 to be combined into video stream A1+A2+An 552. Once the video components are combined into a master video stream, the master stream is provided to the video publisher 564 that ensures that the master video stream reaches all of the chat participants A1 512, A2 514, An 516 and any chat viewers, such as chat viewer A5 518 associated with chat instance controller A 510.

The chat instance controller A 510, and all other chat instance controllers on a given communication system 530, are made up of data objects that incorporate a unique chat ID which is associated with a set of chat participants and any chat viewers. In this case, chat participant A1 512, chat participant A2 514, and chat participant An 516 make up chat instance A, operating on chat instance controller A 510 allocated to that chat instance. Chat viewer 518 may be associated with chat instance A and, similarly, operate on chat instance controller 510 as a chat viewer (not a chat participant). This means that audio and/or video components generated by these chat participants and viewers that is meant for the chat ID associated with chat instance A will be appropriately routed by the chat instance controller A 510 to these chat participants and chat viewers. Similarly, any resulting combined or master streams will be routed back to the appropriate chat participants and chat viewers.

The chat instance controller 510 may receive (from the chat router 444, through the communication interface 432), as a part of an ongoing chat instance, such as chat instance A, video components from the chat participants. Examples of such video components are shown as video component A1 522, video component A2 524, and video component An 526.

These components are routed to a transcoder controller A 592 allocated on the server 500 for a chat instance A. In this case, video components associated with chat instance A are routed to transcoder controller A 592. Similarly, video components associated with chat instance B 520 are routed to transcoder controller B 594 and to transcoder B 570 associated with chat instance controller B 520. Video components associated with chat instance n 530 are routed to transcoder controller n 596 and to transcoder n 580. The transcoders, such as transcoder A 560, accept a plurality of video components, prepare those components for encoding, and package those components for encoding using GPU 550.

The GPU 550 within the server 500 is used for encoding into a single video stream including the video components of A1 522, A2 524 and An 526. This is encoded as video stream A1+A2+An 552. User and/or server settings may determine how this encoding takes place. For example, the videos may be overlaid, may be boxed into set portions of an overall stream (when displayed) or may otherwise be organized into a single master A1+A2+An 552 stream. In addition, timing data may be transmitted with the video components in order to enable the GPU to properly synchronize video data that is not necessarily received simultaneously from all of the chat participants. This same master stream may then be returned to all of the chat participants A1 512, A2 514, An 516 and to any chat viewers, such as chat viewer A5 518.

This master stream may be transmitted using user datagram protocol (UDP). UDP prioritizes throughput over ensured delivery. In this way, the master stream is continuously sent, regardless of whether a particular chat participant or chat viewer has received or acknowledged delivery. The most important priority is ensuring that the master stream continues to be sent, not ensuring that every participant (one or more may have intentionally or unintentionally dropped out of the chat) has received every frame of video or audio.

The resulting video stream utilizes substantially less bandwidth than directly providing each, individual video component to each of the chat participants and each chat viewer for combination therein. Similarly, this process utilizes less CPU cycles on any one of the chat participant computing devices than would be necessary for that computing device to encode all of the video into a single stream or for each participant or viewer computing device to simultaneously receive, decode, synchronize and then display each of these video components. This is particularly acute when there are many chat participants and each of the chat participant's resulting video streams or when many or all of the chat participants are on mobile devices.

The use of a server, such as server 500 at all is unusual in these types of systems. Typically, these systems rely upon the computing power of one or more of the chat participant's computing devices to encode some or all of the video for each of the chat participants in a given video chat session. Particularly in the context of an entirely-mobile video chat session, the chat participant computing devices are not necessarily capable of performing this function. The bandwidth considerations and latency issues related to mobile devices in addition to the more-limited computing power associated with such devices makes using those devices to perform these functions difficult or impractical.

As a result, a server, such as server 500, is used to perform these functions. However, again, utilizing a single server to perform the encoding of more than a few (3-5) simultaneous chats involving a few (3-5) chat participants results in that server being overloaded and, in some cases, ceasing to function or becoming otherwise unavailable. The raw data associated with multiple video streams alone is very bandwidth and memory intensive. A single server has difficulty keeping up with such huge volumes of data, both in network bandwidth and in CPU throughput. Adding additional servers is an option, but each additional server costs money to initialize, to maintain and to administer. The costs associated with providing an individual, dedicated server for each set of only a few simultaneous on-going audio-visual chat sessions makes continued allocation of additional servers prohibitive.

As a result, the present system may use servers which incorporate a plurality of GPUs operating simultaneously within each of the servers to provide additional processing power necessary to overcome the single-server limitations regarding a total number of simultaneous chat sessions. In particular, the GPU's direct access to high-speed memory and the GPUs capability to simultaneously operate on large chunks of data enable the GPUs to quickly synchronize and encode multiple, simultaneous video components into a plurality of combined and master video streams. The CPU, the primary processor for a server, may primarily operate the transcoder controller 590 for a given server 500 and direct the various video streams to their appropriate places where they may then be operated upon by the GPUs. In this way, a single server, having at least one GPU, of current, typical capability may handle anywhere from 5-100 simultaneous chats involving three or more individual chat participants and any number of chat viewers. Additional simultaneous chats may be possible under the same system using later server and GPU technology.

The GPU 550 encoding the video uses lock-free memory, meaning that no single chat participant or chat instance can make any part of the data in memory un-editable. This serves to enable the encoding process to continue operating even if one or more chat participants have high latency or are non-responsive. In addition, incoming new video components are not skipped in the encoding process. So, for example, if additional video data comes in for one chat participant while the remaining chat participants have yet to provide data, the video for the single chat participant is encoded along with the last video component received for the remaining chat participants so as to continue the master video stream advancing, even though only a single participant has provided new data. The GPU does not “lock” any data awaiting input from other chat participants.

In addition, the GPU 550 may utilize blocking of data such that large collections of data are operated upon simultaneously. These collections may be time-allocated, meaning that they are allocated in collections based upon when the video components arrive at the GPU 550. These collections may be type-allocated, meaning that similar video portions that are received within a reasonable time-frame of one another may be grouped for processing because the GPU 550 can perform similar operations at once on different collections of data.

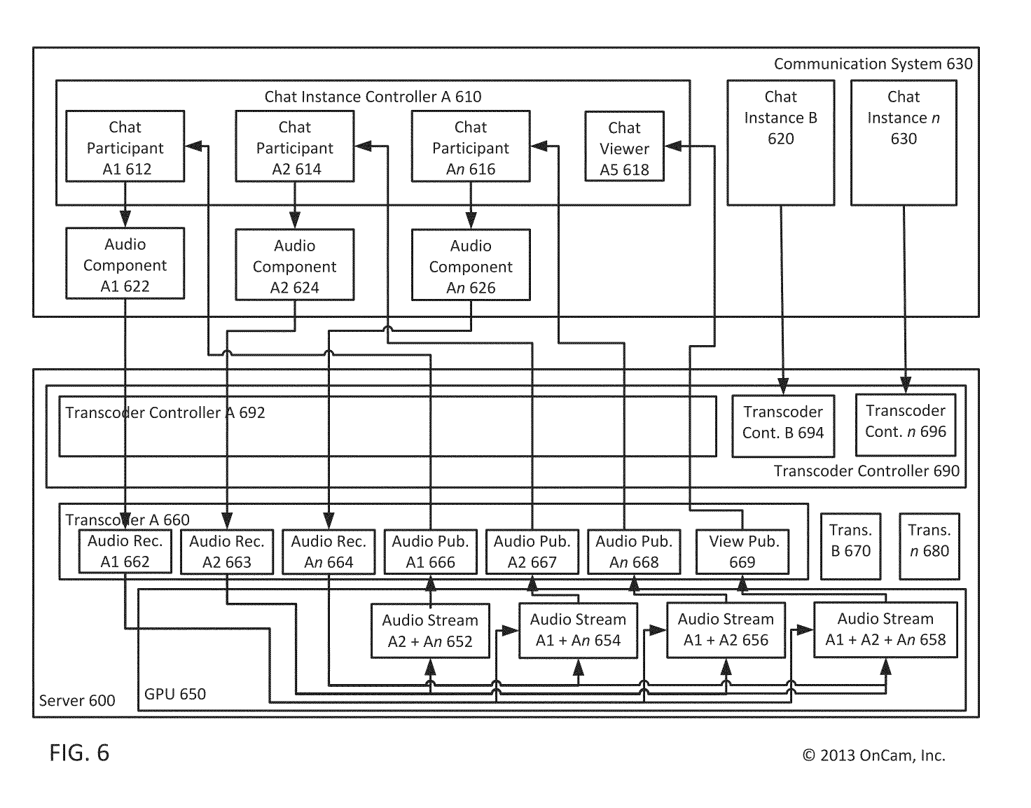

FIG. 6 is a functional diagram of a server 600 and a communication system 630 for audio encoding. The communication system 630 incorporates all of the elements of the communication system 530 in FIG. 5. The chat instance controller A 610, chat instance controller B 620, the chat instance controller n 630, the transcoder controller 690 and the GPU 650 may serve virtually identical functions to that described above with reference to FIG. 5, except those systems function in the same manner with regard to audio components and combined or master audio streams rather than video components and streams. Those descriptions will not be repeated here.

Unlike the video transcoding described above, each audio transcoder, such as transcoder A 660, includes an audio receiver for each chat participant in an associated chat instance controller, such as chat instance controller A 610. Similarly, an audio publisher for each chat participant, along with a single audio publisher used for each chat viewer is provided. For chat instance controller A 610, there are three chat participants, A1 612, A2 614, and An 616 along with a single chat viewer A5 618. Accordingly, there are three audio receivers A1 662, A2 663, and An 664, three audio publishers A1 666, A2 667, and An 668, and one viewer publisher 669.

The audio components A1 622, A2 624, and An 626 are each received in transcoder A 660 at their respective audio receivers A1 662, A2 663, and An 664. These are passed to the GPU 650 for encoding.

Once the GPU 650 receives audio components A1 622, A2 624, and An 626 from the transcoder A 660, the GPU 650 simultaneously encodes n combined audio streams where n is the total number of chat participants. Each of these individual combined audio streams incorporates all of the audio associated with every chat participant except for one. The GPU 650 then returns the n combined audio streams to the respective audio publisher in transcoder A 660 which routes the combined audio streams such that the missing audio component for a given chat participant is their own audio component.

The audio publisher A1 666 receives the audio stream A2+An 652, the audio publisher A2 667 receives the audio stream A1+An 654, and the audio publisher An 668 receives audio stream A1+A2 656. Finally, the viewer publisher 669 receives a master audio stream A1+A2+An 658. Audio publisher A1 666 passes the received audio stream A2+An 652 to chat participant A1 612. Audio publisher A2 667 passes the received audio stream A1+An 654 to chat participant A2 614. Audio publisher An 668 passes the received audio stream A1+A2 656 to chat participant An 616. Chat viewer A5 618 receives the master audio stream A1+A2+An 658.

Among other benefits, this results in none of those participants receiving a so-called “echo” effect wherein their own audio is repeated and reverberates in their own microphone/speaker combination and results in substantial feedback or all chat participants. In addition, this results in less bandwidth usage.

Any chat viewers, such as chat viewer A5 618, receive a master audio stream A1+A2+An 658 incorporating all audio components that are also encoded by the GPU and transmitted, through the chat instance controller 610, to all chat viewers, such as chat viewer A5 618. In this way, the chat viewers receive all audio along with the master video discussed with reference to FIG. 5.

As with the video components above, a CPU in a server can quickly be overwhelmed by the encoding of multiple audio components, for multiple chat participants across multiple, simultaneous chats. The user of a plurality of GPUs to synchronize and encode the audio for each of the on-going chats enables a single current server to handle 10-80 simultaneous chats. Future servers, incorporating better GPUs may increase this number dramatically.

Description of Processes

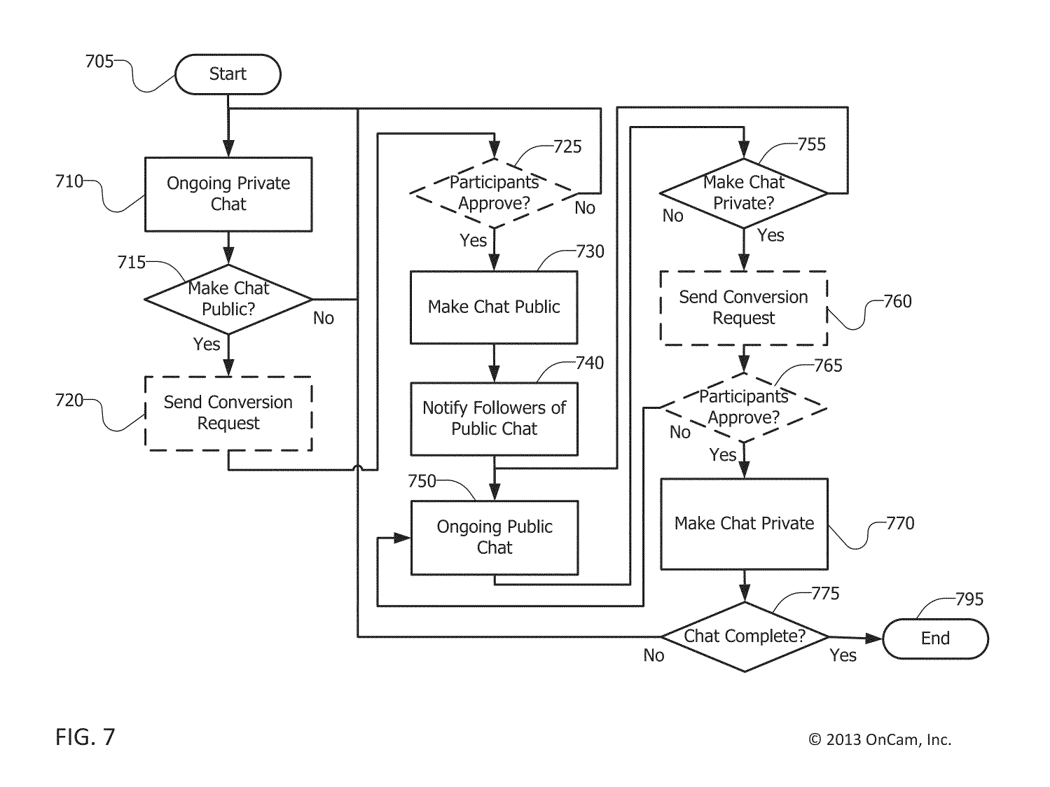

Referring now to FIG. 7, a flowchart of a public-private chat process is shown. FIG. 7 has both a start 705 and an end 795, but the process is cyclical in nature and many instances of the process may be taking place at once. One or more of the computing devices identified above may be programmed to carry out these steps, using these steps as their algorithm.

The flowchart begins after start 705 with an ongoing private chat at 710. The process for initiating a private chat involves one or more individuals using a computing device to request a chat with another individual. Once all users have accepted the chat and the chat has commenced, it is an ongoing private chat in the sense that it involves only those chat participants who have agreed to take part in the chat and no chat viewers are present.

At 715, one of the chat participants taking part in the private chat requests that the chat be made public. This may take place via graphical user interface (GUI) or a physical button on or connected to a computing device. If a chat participant does not elect to make a chat public at 715, then the ongoing private chat continues at 710.

If the chat participant does elect to make a chat public at 715, then, optionally, a conversion request is sent at 720 to each of the other chat participants. This conversion request may be sent via a protocol request identifying a particular type of request, such as the conversion request.

If a conversion request is sent, then, optionally, the participants do not approve of the conversion request at 725, then the chat continues as an ongoing private chat at 710. The approval required at 725 may be each of the other private chat participants or may only require that a majority of the other participants approve.

Alternatively, the conversion request may not be required and, instead, a single chat participant, such as the chat initiator, may be empowered to make a chat public as desired. In such a case, the single chat participant may decide to make the chat public at 715.

If the participants approve at 725 or if no approval is required, then the chat is made public at 730. Making a chat public means that the chat is made available for a plurality of chat viewers who provide no audio and/or video stream for the chat, but are able to view and/or hear the chat.

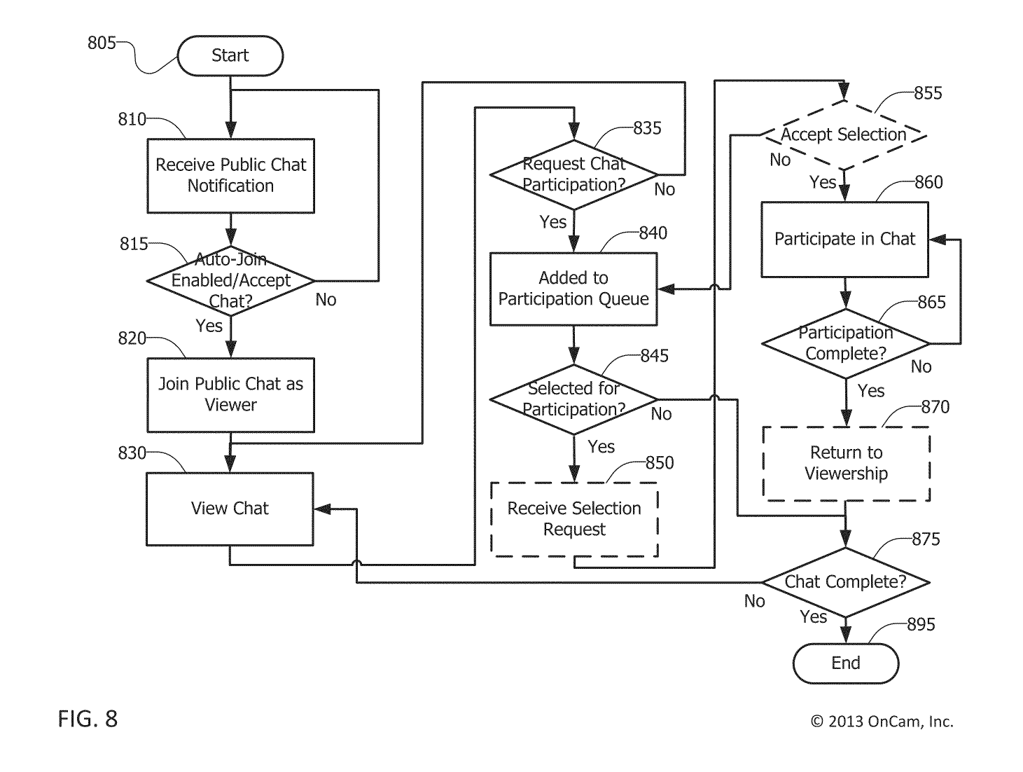

When the chat is made public at 730, followers of one or more of the chat participants may be notified that the chat has been made public and of the identities of the other chat participants at 740. A “follower” is an individual who has subscribed to or otherwise automatically views or accesses social network updates provided by another individual. For example, one celebrity could set up an impromptu audio/visual chat with another celebrity. The two may chat for a period of time privately. Once the two agree to make their chat public for a time, chat viewers who have indicated a willingness to know about when one or both of the celebrities enable a public chat may be automatically notified at 740. In addition, as shown in FIG. 8 below, those followers may automatically join the now-public chat as viewers.

The chat is then made public and the chat participants begin participating in the ongoing public chat at 750 with any number of chat viewers. Chat viewers may be able to communicate via textual means, with the public chat participants, with one another or both, while not participating in the chat. The chat participants may or may not see this textual communication amongst the chat viewers.

The chat participants may, at any point, elect to make a chat private at 755. This will end the public availability of the public chat, but the chat will continue amongst the participants, thus converting the chat private.

This process may optionally involve another conversion request at 760 and participant approval at 765. In some cases, a single chat participant's request to convert the chat from public to private will immediately result in the chat becoming private. In other cases, a conversion request at 760 and participant approval at 765, by either all chat participants or a majority of chat participants, may be required.

Afterward, the chat will again be made private at 770. If the chat is complete at 775, the chat ends at 795. If the chat is not complete at 775, then the process may continue at 710.

Turning now to FIG. 8, a flowchart of a process of joining private-public chat is shown. FIG. 8 has both a start 805 and an end 895, but the process is cyclical in nature and many instances of the process may be taking place at once. One or more of the computing devices identified above may be programmed to carry out these steps, using these steps as their algorithm.

The process begins after start 805, when a public chat notification is received at 810. This may be the notification sent at 740, described with respect to FIG. 7. The notification indicates that one or more individuals or a chat viewer has previously indicated an interest in seeing if a public chat has begun.

This notification may take place via an application, such as a chat application, operating on a computing device, such as a computer, tablet, or mobile device, operated by the chat viewer. Alternatively, this notification may take place via a text message, via a notification integrated into one or more social networks such as Twitter® or Facebook®.

The chat viewer may have indicated his or her interest in seeing a public chat involving an individual by “following” that individual on a social network, by specifically indicating an interest within an application or website, by identifying a specific previously-identified event in which the chat viewer is interested, or by simply being “connected to” an individual in a chat contact list or user group.

Next, a determination is made whether the user has auto-join enabled or otherwise accepts the chat at 815. Auto-join may be a setting enabled by a chat viewer that causes a chat application, website or mobile device to automatically begin viewing a chat provided by one of the individuals identified by the chat viewer. This setting may be set application- or website-wide, or may be set for specific individuals in which the chat viewer is particularly interested.

If auto-join is enabled for this chat participant, the chat viewer's chat application, mobile device, or chat website may automatically begin viewing the ongoing public chat at 820. “Automatically” in this patent means “without human intervention.”

If auto-join is not enabled, a determination is made whether the user accepts the chat notification at 815. If accepted, the chat viewer joins the public chat at 820. If auto-join is not enabled and the user does not accept the chat at 815, then nothing happens and the process awaits a subsequent notification at 810.

After the viewer has joined the public chat as a viewer at 820, then the chat viewer can view the chat at 830. As discussed above, a chat viewer may be able to communicate with other chat viewers, outside of the public chat.

Next, the viewer may request chat participation at 835. This process is a way in which a chat viewer indicates that he or she would like to participate in the chat as a chat participant. This may be, for example, a town hall style meeting with a congressperson in which the public is invited to take part as chat viewers. A particular chat viewer may indicate that he or she would like to take part in the chat as a chat participant for a time in order, for example, to ask a question of the congressperson. For a limited time, that chat viewer may begin streaming audio and/or video for inclusion in the chat. After this participation has completed, the question has been asked, the chat participant may be returned to the status of a chat viewer.

If participation is denied at 835, then the chat viewer will continue to view the chat at 830. The chat viewer may be added to a participation queue at 840 storing a list of chat viewers who would like to join the ongoing public chat.

A chat participant may view the participation queue and select one or more chat viewers in the participation queue to join the public chat at 845. If a chat viewer is not selected at 845, and the chat is complete at 875, then the process can end at 895. If the chat viewer is not selected at 845, and the chat is not complete at 875, then the chat viewer can continue to view the chat at 830.

If the chat viewer is selected for participation at 845, then he or she may, optionally, be provided the opportunity to receive the selection request at 850 and to accept selection at 855. In some cases, the user may immediately be placed into participation in the chat at 860. In other cases, the user may receive a selection request at 850 and accept the selection at 855 before being placed in participation in the chat at 860. If the user does not accept the selection at 855, he or she may be returned to the participation queue at 840 or, alternatively, dropped from the queue and allowed to continue as a chat viewer.

If the participation is not complete at 865, then the participation in chat continues at 860. This may take place if the other chat participants particularly enjoy the chat viewer's participation in the chat or if there are follow-up questions. Alternatively, chat viewer conversion to chat participant may be permanent for a particular chat.

Once the participation is complete at 865, then the chat viewer may, optionally, be returned to viewership at 870. In this situation, the chat viewer again is unable to participate in the chat and merely views and/or hears the ongoing public chat as a chat viewer.

A determination is made whether the chat is complete at 875 and, if so, the process ends at 895. If the chat is not complete at 875, then the process reverts to chat viewing at 830.

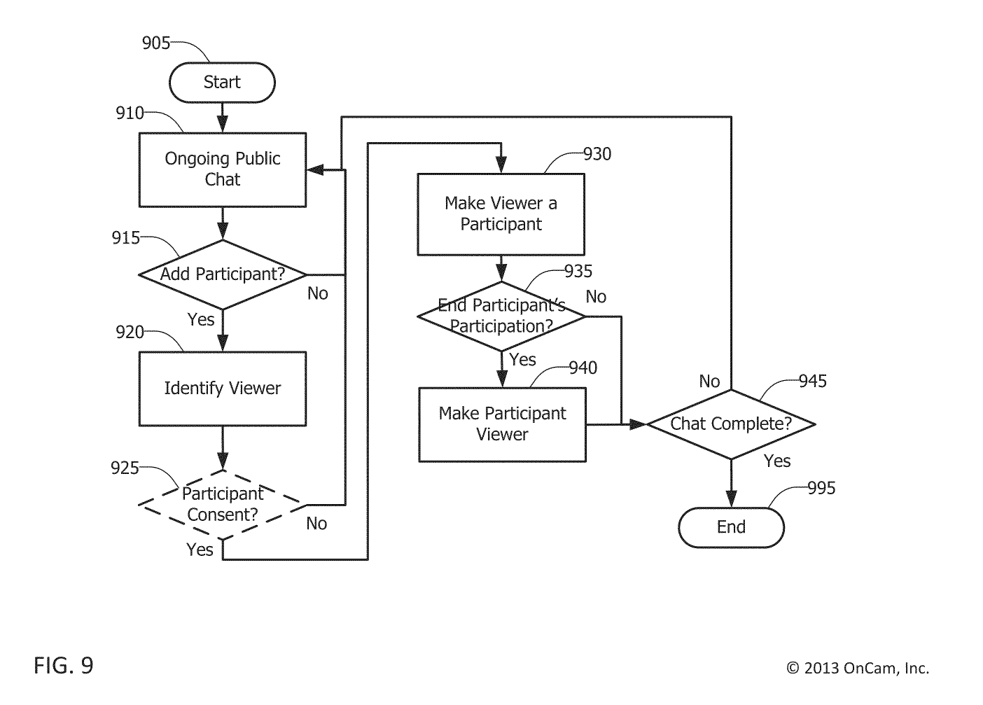

Turning now to FIG. 9, a flowchart of a process of adding and removing public chat participants is shown. FIG. 9 has both a start 905 and an end 995, but the process is cyclical in nature and many instances of the process may be taking place at once. One or more of the computing devices identified above may be programmed to carry out these steps, using these steps as their algorithm.

The process begins after start 905, with an ongoing public chat at 910. An ongoing public chat is described above with respect to FIG. 8 and that description will not be duplicated here.

Next, a determination is made whether to add a participant to the ongoing public chat at 915. If the determination is not to add a participant, then the chat continues at 910. If the determination is to add a chat participant, then the chat viewer to be added is identified at 920. This may involve the selection of one of the chat viewers who has added himself or herself to the participation queue (at 840, FIG. 8) or may be a randomly-selected chat viewer.

The chat viewer may, optionally, have to provide consent to be made a participant at 925. In some cases, merely adding oneself to the chat participation queue may act as consent to be made a participant. In other cases, no consent at 925 will be required.

Once the viewer has been identified at 920 and given consent (if required) at 925, then that chat viewer will be made a chat participant at 930. This may be for a predetermined period of time (e.g. 90 seconds) or may be until a particular process is completed (e.g. a question is asked) or may be until the new chat participant is actively removed by the original chat participants.

At 935, a determination is made as to whether to end the chat participant's participation as a chat participant. If the determination is not to end the participant's participation at 935, then a determination is made as to whether the chat is complete at 945. If yes, then the process ends at 995. If not, then the participant continues in the ongoing public chat at 910.

If the determination is to end the new chat participant's participation at 935, then the new participant is made a viewer at 940—meaning that the new chat participant continues viewing the chat as a chat viewer, but no longer provides an audio and/or video component that is incorporated into the chat.

Again, once the chat is complete, the process ends at 995. If the chat is not complete, the chat viewer continues viewing the ongoing public chat at 910 and the process continues from that point.

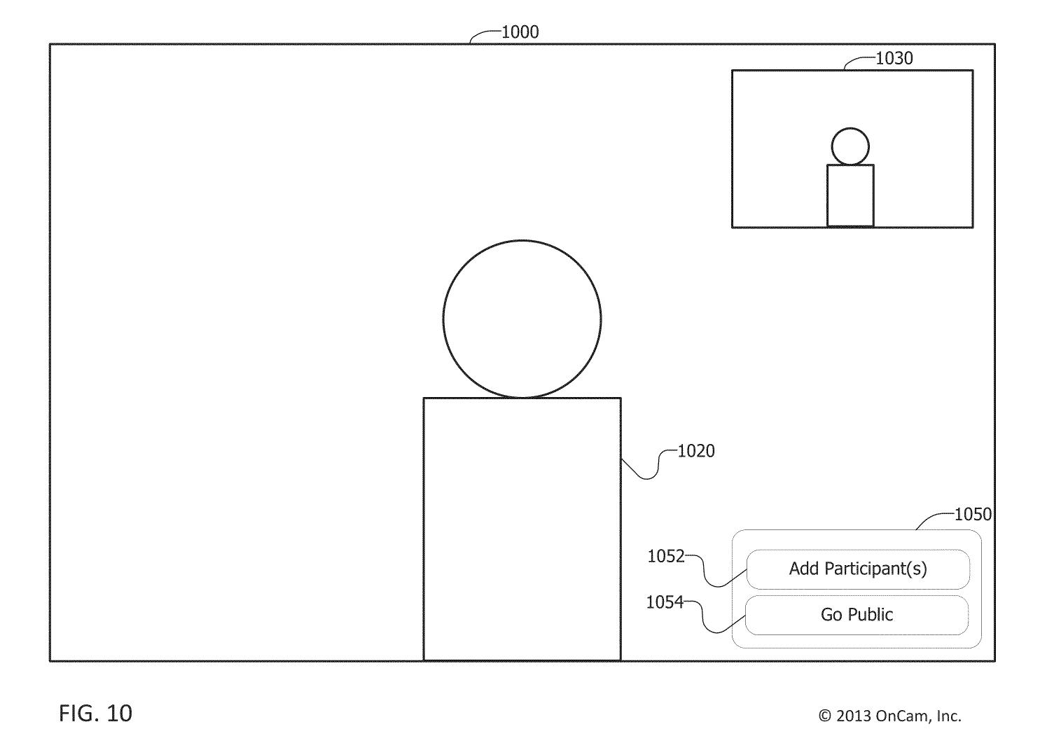

FIG. 10 shows a graphical user interface for a public-private chat. Each of the following FIGS. 10-13 are merely examples of a graphical user interface (GUI) that may be used along with the processes and systems described herein. Other GUIs may be used incorporating different functions and operations than those shown herein. This GUI may appear on a computing device of one or more chat participants.

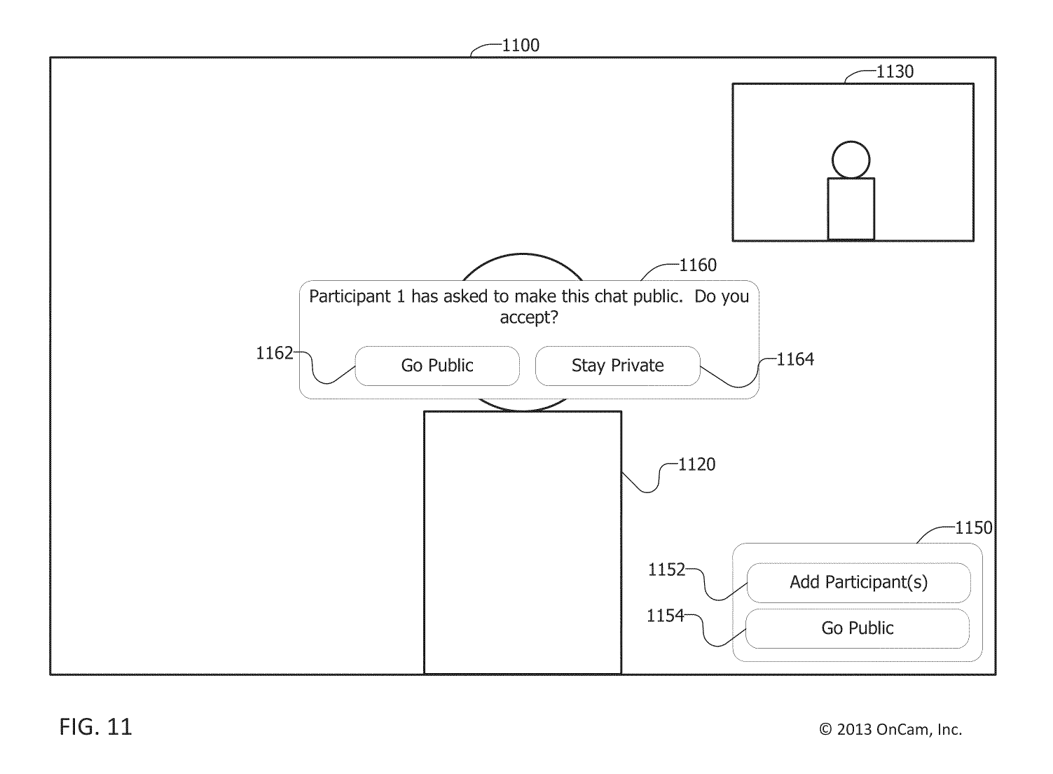

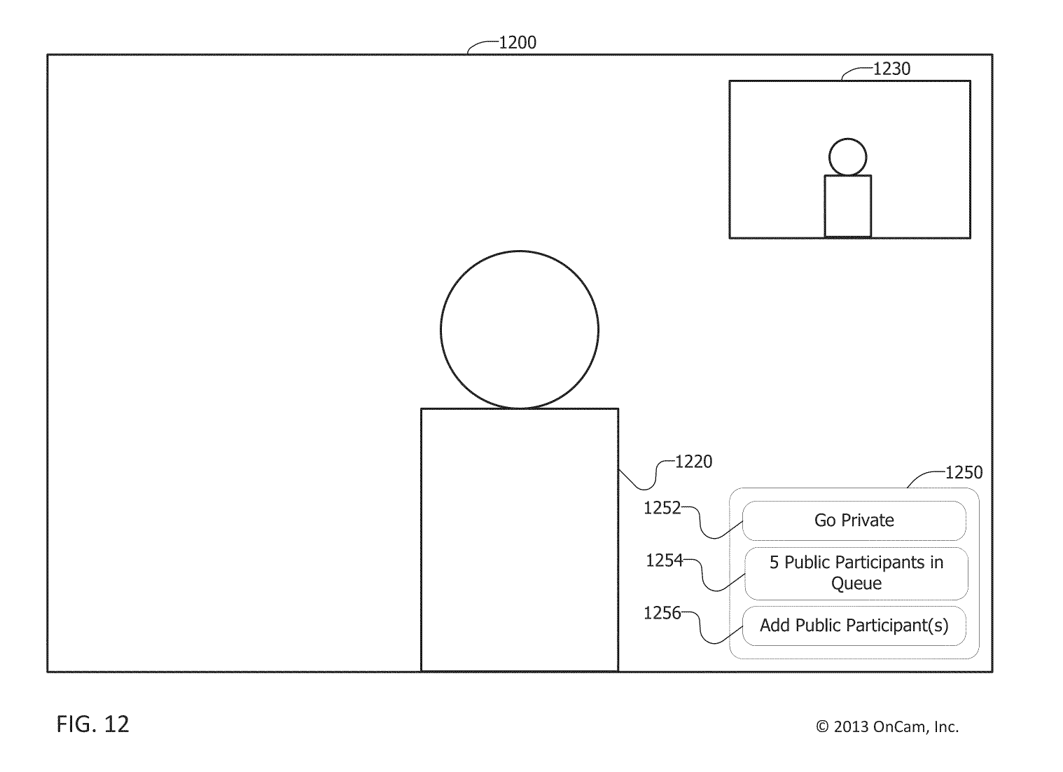

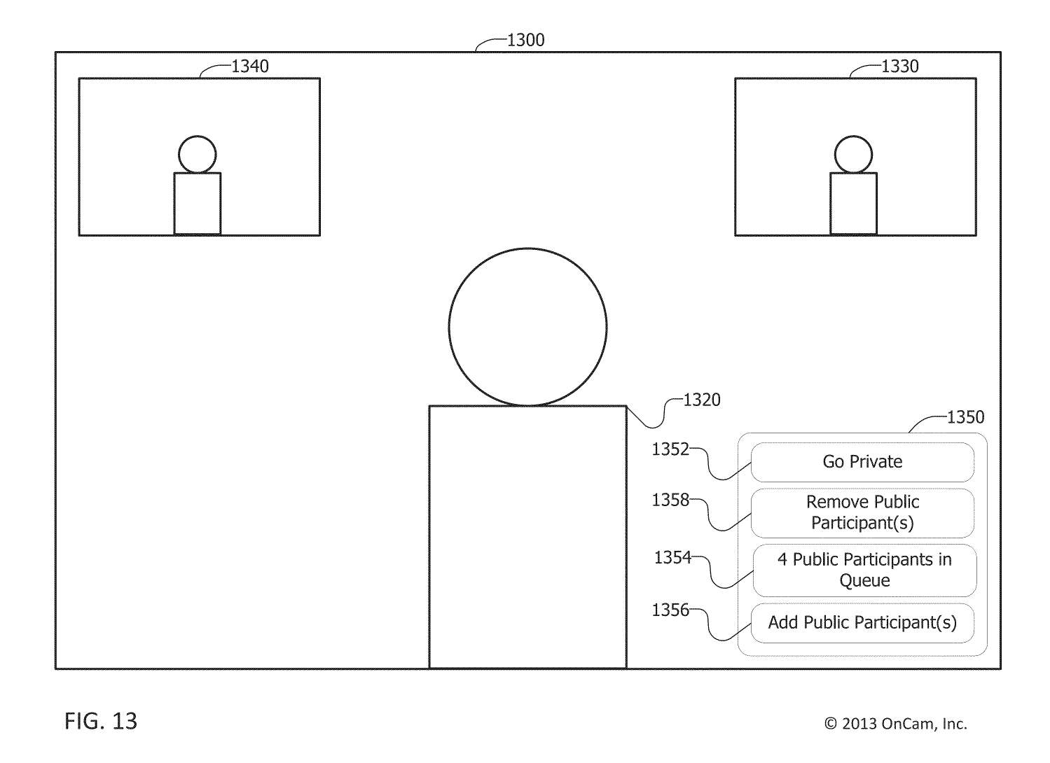

FIG. 10 includes a chat window 1000, with a first chat participant 1020, a second chat participant 1030 and a user interface (UI) console 1050 including two buttons; an add participant(s) button 1052 and a go public button 1054. FIGS. 10 and 11 show a private chat, while FIGS. 12 and 13 show a public chat that was converted from the private chat of FIGS. 10 and 11.

The first chat participant 1020 may be a chat participant using the chat system and may be visible on the display. The second chat participant 1030 is another chat participant using the chat system to take part in a chat with the first chat participant. This second chat participant 1030 is also visible on the display.

The UI console 1050 may include many more functions or may be oriented or arranged differently than shown, but two buttons signify two functions that are described herein.

First, the user may elect to add further participants via the add participant(s) button 1052. This functionality may be implemented in or as a part of a contact list in a chat application and may involve clicking on a username of an additional chat participant or selecting to add that username to an ongoing chat. Alternatively, as shown here, an add participant(s) button 1052 may enable further participants to be added.

Second, the go public button 1054 enables a chat participant to request that the chat be made public (as described with reference to FIG. 7). Selecting this button causes the chat to be made public or causes the conversion request (720, FIG. 7) to be sent to the second chat participant before the chat is made public.

FIG. 11 shows a graphical user interface for making a private chat into a public chat. FIG. 11 includes numerous elements that are present in FIG. 10. Descriptions of these elements will not be recreated here.

In addition, FIG. 11 includes a conversion request popup window 1160. The conversion request popup window 1160 may appear to the second chat participant before a chat is made public. The second chat participant may be required to give approval (725, FIG. 7). As discussed above with respect to FIG. 7, approval of more than one chat participant may not be required. Here, the second chat participant may select the go public button 1162 or the stay private button 1164. The go public button 1162 indicates the second chat participant's approval to go public and begin broadcasting the chat to any number of chat viewers. The stay private button 1164 indicates the second chat participant's desire for the chat to remain private.

FIG. 12 shows a graphical user interface for adding a viewer as a participant in a public chat. The GUI includes many elements that were described above with respect to FIG. 10. That description will not be repeated here. This figure is representative of a display of a chat after it has been converted from a private chat into a public chat.

The UI console 1250 includes a go private button 1252, a participation queue indicator 1254, and an add public participant(s) button 1256.

The go private button 1252 enables one or both of the chat participants to cause the chat to revert to a private chat. Approval of other chat participants may be required (765, FIG. 7).

The participation queue indicator 1254 shows the number of individuals in the participation queue. Activating the participation queue indicator may cause the usernames or other identifying information (such as a stream of the audio and/or video) to be visible to the chat participants. In this way, the chat participants may preview a chat viewer before adding them to the chat as a chat participant. Alternatively, this functionality may be made available to a non-participating chat organizer (similar to a call screener). In such a scenario, the chat organizer may preview potential chat participants before they are added to an ongoing public chat.

The add public participant(s) button 1256 enables the chat participants to add one or more of the chat viewers (in the participation queue or not) to the chat. This process may also involve the use of an audio and/or video preview to ensure that the chat participants can pre-screen the chat viewer that is to be added as a chat participant before they are added to the chat.

FIG. 13 shows a graphical user interface for removing a participant or making a public chat private. The GUI includes many elements that were described above with respect to FIG. 10. That description will not be repeated here.

FIG. 13 includes a chat viewer who has been added as a third chat participant 1340. The UI console 1350 also includes a remove public participant(s) button 1358 that enables chat participants to return the public chat to one with only the first chat participant 1320 and the second chat participant 1330. Alternatively, the remove public participant(s) button 1358 may be used to remove specific chat viewers from active participation in the chat.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A public-private chat system comprising a server for:
initiating a private chat between a first chat participant using a first computing device and a second chat participant using a second computing device;
receiving a request to convert the private chat into a public chat available for viewing by a non-participating chat viewer, the request from the first computing device;
automatically sending a notification to followers of at least one of the first chat participant and the second chat participant that the public chat is about to commence; and
enabling access to the chat by the non-participating chat viewer.

2. The public-private chat system of claim 1, wherein the server is further for receiving an acceptance of the request to convert from the second computing device before automatically sending a notification to followers of at least one of the first chat participant and the second chat participant that the public chat is about to commence.

3. The public-private chat system of claim 1 wherein the chat comprises an audio stream and a video stream, each made up of audio components and video components from the first computing device and the second computing device.

4. The public-private chat system of claim 1 wherein the notification includes a selected one of a hyperlink, an embedded video file, and a mobile device notification.

5. The public-private chat system of claim 1 further comprising a third computing device associated with a second non-participating chat viewer, wherein the third computing device is configured to automatically begin accessing the public chat upon receipt of the notification.

6. The public-private chat system of claim 1 wherein the server is further for:
receiving a request to end the public chat from one of the first computing device and second computing device;
disabling access by the non-participating chat viewer to the public chat; and
continuing a chat between the first chat participant and the second chat participant as a renewed private chat.

7. The public-private chat system of claim 1 wherein the server is further for:
receiving a conversion request by the non-participating chat viewer to become a third chat participant;
receiving acceptance of the conversion request from at least one of the first chat participant and the second chat participant; and
enabling the third chat participant to participate in the public chat.

8. The public-private chat system of claim 7 wherein the third chat participant participates in the public chat for a pre-determined time period after which the participation of the third chat participant is disabled and the third chat participant again becomes the non-participating chat viewer.

9. The public-private chat system of claim 8 wherein the pre-determined time period is selected by one of the first chat participant and second chat participant.

10. A method comprising:
initiating a private chat between a first chat participant using a first computing device and a second chat participant using a second computing device;
receiving a request to convert the private chat into a public chat available for viewing by a non-participating chat viewer, the request from the first computing device;
receiving an acceptance of the request to convert from the second computing device;
automatically sending a notification to followers of at least one of the first chat participant and the second chat participant that the public chat is about to commence; and
enabling access to the chat by the non-participating chat viewer.

11. The method of claim 10, further comprising receiving an acceptance of the request to convert from the second computing device before automatically sending a notification to followers of at least one of the first chat participant and the second chat participant that the public chat is about to commence.

12. The method of claim 10 wherein the chat comprises an audio stream and a video stream, each made up of audio components and video components from the first computing device and the second computing device.

13. The method of claim 10 wherein the notification includes a selected one of a hyperlink, an embedded video file, and a mobile device notification.

14. The method of claim 10 further comprising a third computing device associated with one non-participating chat viewer, wherein the third computing device is configured to automatically begin accessing the public chat upon receipt of the notification.

15. The method of claim 10 further comprising:
receiving a request to end the public chat from one of the first computing device and second computing device;
disabling access by the non-participating chat viewer to the public chat; and
continuing a chat between the first chat participant and the second chat participant as a renewed private chat.

16. The method of claim 10 further comprising:
receiving a conversion request by the non-participating chat viewer to become a third chat participant;
receiving acceptance of the conversion request from at least one of the first chat participant and the second chat participant; and
enabling the third chat participant to participate in the public chat.

17. The method of claim 16 wherein the third chat participant participates in the public chat for a pre-determined time period after which the participation of the third chat participant is disabled and the third chat participant again becomes the non-participating chat viewer.

18. The method of claim 17 wherein the pre-determined time period is selected by one of the first chat participant and second chat participant.
